(19) United States
(12) Patent Application Publication
(10) Pub. No.: US 2026/0296256 A1
(43) Pub. Date: Oct. 1, 2026

(54) CERTIFICATELESS ELECTRIC VEHICLE CHARGING SYSTEM USING EVSE MAC ADDRESS FOR CLOUD-BASED AUTHENTICATION AND ACTIVATION

(71) Applicant: American Honda Motor Co., Inc., Torrance, CA (US)

(72) Inventor: Stanley J BRADBURY, Saline, MI (US)

(21) Appl. No.: 19/096,321

(22) Filed: Mar. 31, 2025

(51) Int. Cl. B60L 53/66; B60L 53/68; H04L 61/50; H04W 4/44; H04W 12/06; H04W 76/19

(52) U.S. Cl. CPC B60L 53/665; B60L 53/68; H04L 61/50; H04W 4/44; H04W 12/06; H04W 76/19

(57) ABSTRACT

The present disclosure describes a certificateless electric vehicle charging system using an EVSE MAC address for cloud-based authentication and activation. In one implementation, an electric vehicle (EV) may receive a media access control (MAC) address from an electric vehicle supply equipment (EVSE) during a physical connection and transmit the MAC address, along with a user identifier, to a cloud-based authentication server. The server may map the MAC address to a unique EVSE identifier and verify an active user subscription and payment method. Upon successful authentication, the server may transmit a remote start request to the EVSE to initiate the charging session. Advantageously, this approach may eliminate the need for digital certificates, reducing complexity, engineering cost, and failure rates associated with certificate-based Plug and Charge systems. The system may be interoperable across different charging networks and provides a more reliable, scalable, and user-friendly alternative to conventional certificate-based charging protocols.

### BACKGROUND

Electric vehicle (EV) charging systems are rapidly evolving to enhance user convenience, interoperability, and security. One widely discussed approach for streamlining the EV charging experience is Plug and Charge (PnC), standardized under ISO 15118. PnC allows drivers to simply plug in their vehicle to a charging station and initiate charging automatically through digital certificates and cryptographic protocols that authenticate the user and authorize payment.

However, PnC systems face significant technical and operational challenges. These include complex certificate management, frequent failures due to expired or improperly installed certificates, and difficulty supporting multiple public key infrastructures (PKIs) and electric mobility service providers (eMSPs). The certificate-based approach also limits the ability to personalize charging across multiple users, increases engineering and operational costs, and is not universally supported across charging networks or charging station operators (CPOs).

There is a need for a simplified, more reliable, and universally compatible solution for EV charging that eliminates the complexity and drawbacks associated with digital certificates. This present disclosure addresses that need by introducing a certificateless “Plug-in And Recharge” (PAR) system that uses the MAC address of the charging station to enable cloud-based authentication and session activation, thereby improving reliability, reducing costs, and enhancing the user experience.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a system for enabling certificateless electric vehicle (EV) charging is provided. The system may include an electric vehicle supply equipment (EVSE) configured to transmit a media access control (MAC) address upon physical connection. In addition, the system may include an EV configured to receive the MAC address and send it, along with a user identifier, to a cloud-based authentication server. The cloud-based authentication server may be configured to: map the MAC address to a location and EVSE identifier; verify the user identifier and subscription status; and send a remote start command to the EVSE to initiate charging.

In accordance with another aspect of the present disclosure, an electric vehicle (EV) configured to initiate a certificateless charging session is provided. The EV may include a communication module receiving a media access control (MAC) address from an electric vehicle supply equipment (EVSE) during a handshake procedure upon physical connection. In addition, the EV may include a network interface configured to transmit the received MAC address and a vehicle-associated user identifier to a remote cloud server. The cloud server maps the MAC address to a location identifier and EVSE identifier, verifies an active subscription associated with the user identifier, and transmits a charging session activation command to the EVSE based on the location identifier and EVSE identifier.

In accordance with yet another aspect of the present disclosure, a non-transitory computer-readable medium storing instructions that, when executed by a processor of a cloud server, cause the server to perform operations is provided. These operations may include receiving a MAC address and user identifier from a connected EV; mapping the MAC address to a Location ID and EVSE ID; verifying user credentials and payment status; and transmitting a charging session start command to a corresponding EVSE based on the Location ID and EVSE ID.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a diagram indicating high-level system components of the certificateless electric vehicle charging system using an EVSE MAC address for cloud-based authentication and activation in accordance with one aspect of the present disclosure;

FIG. 2 is a diagram of an electric vehicle (EV) initiated charging flowchart from the vehicle's perspective in accordance with one aspect of the present disclosure.

FIG. 3 is a diagram of EV hardware that illustrates internal components of the vehicle in accordance one aspect of the present disclosure;

FIG. 4 shows an EVSE and MAC mapping in a cloud diagram of the cloud server database structure in accordance with one aspect of the present disclosure;

FIG. 5 is a sequence diagram of a SLAC Handshake between an EV and EVSE in accordance with one aspect of the present disclosure;

FIG. 6 depicts a multi-user profile selection in a vehicle user interface in accordance with one aspect of the present disclosure; and

FIG. 7 is a comparison between certificate-based and certificateless charging in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure describes a certificateless electric vehicle charging system using an EVSE MAC address for cloud-based authentication and activation. In one illustrative embodiment, an electric vehicle (EV) may receive a media access control (MAC) address from an electric vehicle supply equipment (EVSE) during a physical connection and transmit the MAC address, along with a user identifier, to a cloud-based authentication server. The server may map the MAC address to a unique EVSE identifier and verify an active user subscription and payment method. Upon successful authentication, the server may transmit a remote start request to the EVSE to initiate the charging session. Advantageously, this approach may eliminate the need for digital certificates, reducing complexity, engineering cost, and failure rates associated with certificate-based Plug and Charge systems. The system may be interoperable across different charging networks and provides a more reliable, scalable, and user-friendly alternative to conventional certificate-based charging protocols.

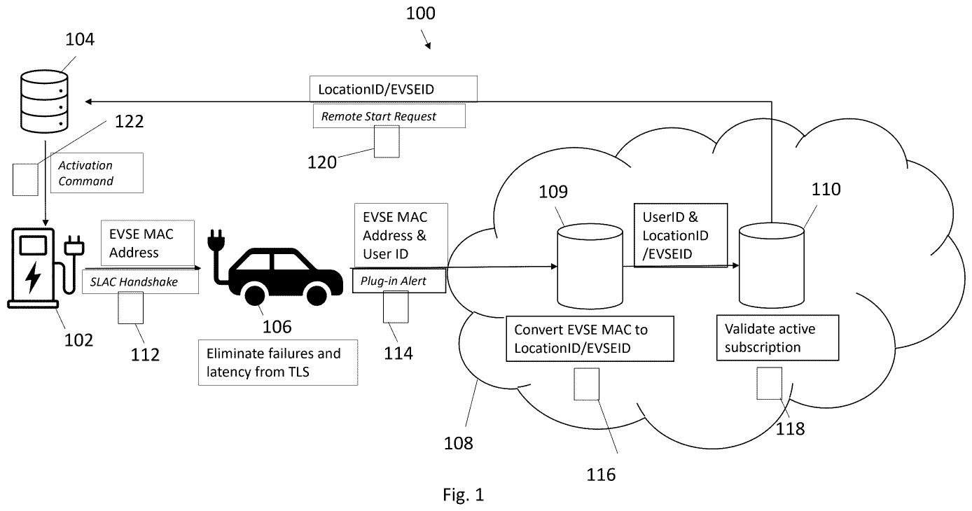

Turning now to FIG. 1, an overview of the system 100 for initiating EV charging sessions without the use of digital certificates is provided. The system 100 may include an EVSE 102, a charging station network 104, an EV 106, and a cloud-based authentication server 108. The cloud-based authentication server 108 may further include a mapped EVSE database 109 and a user subscriptions database 110.

The EVSE 102 may be any type of charging unit capable of supplying electric energy to recharge an EV, including but not limited to Level 2 AC chargers, DC fast chargers, or ultra-fast chargers. The EVSE 102 may be managed by a charge point operator (CPO) and may include hardware and firmware that enable communication with an EV during a physical connection. In one example, the EVSE 102 may be a Supercharger or a DCFC charger. The EVSE 102 may be configured to broadcast a unique media access control (MAC) address during a plug-in event.

The charging station network 104 may represent a distributed infrastructure that includes a plurality of EVSEs 102 managed by a service provider or CPO. The network 104 may be connected to backend systems for scheduling, monitoring, and network load balancing. In certain embodiments, the charging station network 104 may include EVSEs that are not ISO 15118 compliant but still compatible with the system described herein.

The EV 106 may include any type of plug-in electric vehicle capable of interfacing with the EVSE 102 and communicating with remote servers. The EV 106 may be configured to receive the MAC address from the EVSE 102 and transmit it, along with a user identifier, to the authentication server 108. In one embodiment, the EV 106 may be a production electric vehicle manufactured by the assignee of the present application.

The cloud-based authentication server 108 may include one or more computing devices configured to perform remote validation and activation tasks. The server 108 may be operated by an original equipment manufacturer (OEM), e-mobility service provider (eMSP), or other third party. The server 108 may be in communication with both the EV 106 and the EVSE 102 via secure network channels.

The mapped EVSE database 109 may store a plurality of mappings that associate EVSE MAC addresses with corresponding charging station identifiers such as Location IDs or EVSE IDs. Upon receiving a MAC address from the EV 106, the server 108 may query this database to determine the precise identity and location of the EVSE 102 to which the vehicle is connected.

The user subscriptions database 110 may store information corresponding to one or more registered users, including user identifiers, subscription status, and payment method credentials. Upon receiving a request from the EV 106, the server 108 may use the user ID to query the database 110 and confirm that the user is actively enrolled in a valid charging program with sufficient authorization to initiate a charging session.

Upon plug-in, the EV 106 receives the EVSE MAC address and sends it, along with a user ID, to the cloud-based authentication server 108. The server 108 accesses the mapped EVSE database 109 to convert the EVSE MAC address to a Location ID/EVSE ID. It also validates the user's active subscription using the user subscriptions database 110. Upon verification, the cloud server transmits a remote start request to the EVSE 102, enabling the charging session.

This process avoids the complexities and failures associated with certificate-based methods, such as Transport Layer Security (TLS) latency, certificate expiration, and multi-PKI handling.

At block 112, the EVSE 102 may initiate communication by broadcasting its MAC address to the EV 106 upon plug-in. This may be performed using a SLAC (Signal Level Attenuation Characterization) handshake protocol supported over HomePlug Green PHY or equivalent powerline communication protocols.

At block 114, the EV 106 may receive the MAC address and generates a plug-in alert. The EV may then transmit the MAC address and a corresponding user ID to the cloud-based authentication server 108 via a wireless network interface, which may include a cellular or Wi-Fi connection.

The cloud-based authentication server 108 may query the mapped EVSE database 109 to convert the received MAC address into a corresponding Location ID and EVSE ID at block 116, the. The mapped EVSE database 109 may store associations between MAC addresses and location-specific identifiers used to uniquely identify the charging station.

At block 118, the cloud-based authentication server 108 may use the resolved Location ID/EVSE ID and received a user ID to query the user subscriptions database 110. This query validates whether the user associated with the ID has an active subscription and an authorized payment method or billing relationship that permits charging.

Upon successful validation, at block 120, the cloud-based authentication server 108 generates and transmits a remote start request to the charging station network 104. This request includes the resolved Location ID/EVSE ID to specifically address the EVSE 102.

At block 122, the charging station network 104 responds to the remote start request by sending an activation command to the EVSE 102. The EVSE then initiates power delivery to the EV 106, beginning the charging session. This process eliminates the need for Transport Layer Security (TLS), digital certificates, or multi-PKI support, thereby reducing latency and minimizing failure points.

The architecture described through blocks 112 to 122 may provide a flexible, scalable, and certificate-independent solution for secure EV charging, allowing seamless interoperability across multiple charge point operators (CPOs), EVSE networks, and e-mobility service providers (eMSPs).

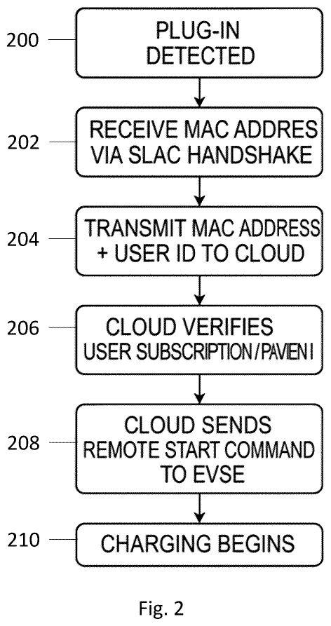

FIG. 2 illustrates a process flow for initiating a certificateless electric vehicle charging session from the perspective of the electric vehicle (EV) at block 200. The flow includes a sequence of operations that may be executed by one or more components of the EV and the cloud-based authentication server.

At block 202, the EV detects a physical connection with an electric vehicle supply equipment (EVSE). This detection may occur via hardware sensors integrated into the charge port or via electrical handshake signals as part of a powerline communication protocol such as HomePlug Green PHY. Upon detection, the EV initiates a SLAC handshake or equivalent process to establish communication.

At block 204, the EV receives a MAC address from the EVSE. The MAC address uniquely identifies the EVSE on the local area network or powerline communication channel. This address may be embedded in SLAC protocol data units or exchanged through proprietary or standardized handshaking protocols.

At block 206, the EV packages the EVSE MAC address along with a user identifier (User ID) and transmits this information to a remote cloud-based authentication server. The transmission may occur over a secure channel using a wireless communication interface, such as a 4G/5G modem, Wi-Fi module, or other telematics control unit (TCU), for example. The user ID may be determined by the vehicle through several mechanisms, including but not limited to: a key fob or smartphone paired with the vehicle; biometric authentication (e.g., facial recognition or fingerprint scan); driver profile selection from the infotainment system; and vehicle-to-user binding via mobile app or in-vehicle UI.

At block 208, the cloud server receives the MAC address and user ID. The server may perform two primary operations: EVSE Resolution and User Authentication. For EVSE Resolution, the server uses the MAC address to query a mapped EVSE database to identify a corresponding Location ID or EVSE ID, which represents the physical and logical identity of the EVSE. For User Authentication, the server queries a user subscriptions database using the user ID to verify that the user has an active subscription or valid billing method that authorizes charging. In some embodiments, this check may involve cross-referencing multiple eMobility Service Providers (eMSPs), applying cost-optimization rules, or determining the user's default provider preference.

At block 210, upon successful authentication and EVSE identification, the cloud server generates a remote start request that is sent to the appropriate charging station or network backend. This request triggers the charging session by instructing the EVSE to begin power delivery. The EVSE may respond with a confirmation message, or the EV may detect the start of charging through current/voltage measurements on the powerline.

In some embodiments, the system may include a fallback mechanism where, if the cloud connection fails or is delayed, the EV may present a time-limited session token generated previously during an authenticated session. The token may be stored in vehicle memory and bound to a specific user ID and MAC address or Location ID.

In another embodiment, the user may be able to override the automatic user selection through an in-vehicle display, allowing manual profile switching prior to sending the cloud request at block 206.

The MAC address may be encrypted by the EV prior to transmission to the cloud server for additional security, and the cloud may perform MAC integrity checks or apply geolocation validation (e.g., checking that the EV's GPS coordinates match the EVSE's registered location) before sending the remote start request.

In yet another embodiment, if the user is associated with multiple active eMSP subscriptions, the cloud server may select the provider based on the lowest available rate, user-defined preferences, or contractual prioritization.

The remote start request of block 210 may also trigger additional operations such as generating a session log, sending notifications to a user mobile app, or enabling EVSE features such as dynamic power throttling or session time estimation.

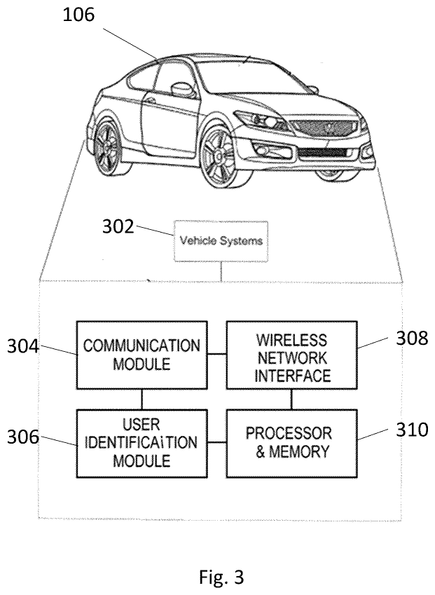

Referring now to FIG. 3, a block diagram illustrates internal hardware components of the electric vehicle (EV) 106 that are configured to support certificateless charging functionality. These components are integrated within a set of vehicle systems 302, which may be implemented in one or more electronic control units (ECUs), a telematics control unit (TCU), or other onboard computing platforms. The vehicle systems 302 may include a communication module 304, a wireless network interface 308, a user identification module 306, and a processor and memory 310.

The communication module 304 may interface with the EVSE using powerline communication (PLC) protocols such as HomePlug Green PHY. It may initiate and manage SLAC handshakes, allowing the EV 106 to receive a MAC address from the EVSE during plug-in.

The wireless network interface 308 provides connectivity to a cloud-based authentication server using technologies such as cellular (e.g., LTE, 5G) or Wi-Fi (802.11). This interface is responsible for securely transmitting the EVSE MAC address and a user identifier to the server and receiving a response that may include a remote start authorization or session data.

The user identification module 306 may determine or confirm the identity of the driver. It may operate through proximity sensors for key fob detection, Bluetooth pairing with a registered mobile device, biometric input (e.g., fingerprint or facial recognition), or a graphical user interface that allows driver profile selection. The user ID obtained from this module is used to authenticate the charging session request.

The processor and memory 310 may include at least one processing unit (such as a microcontroller, SoC, or automotive-grade CPU) and computer-readable memory (including volatile and non-volatile storage). The processor executes program instructions stored in the memory to control the other components shown. These instructions may include logic for detecting a plug-in event, receiving and processing the MAC address, retrieving or validating the user ID, formatting and sending data to the cloud server, and handling cloud-based responses related to the initiation of charging.

In some embodiments, the vehicle systems 302 may also include diagnostic and security subsystems, and may be implemented redundantly or virtually across multiple domains in a software-defined vehicle architecture. Internal communications among these modules may occur over a Controller Area Network (CAN), Automotive Ethernet, or equivalent vehicle bus system.

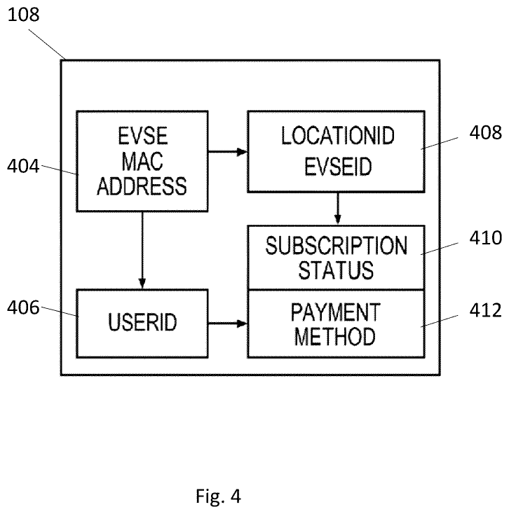

Referring now to FIG. 4, a diagram is shown of the cloud-based authentication server 108, which includes components for resolving EVSE identity and validating user authorization in a certificateless electric vehicle charging system. The components of the server 108 operate collectively to determine whether to authorize a charging session based on a MAC address received from an EV and an associated user identifier (User ID).

The server 108 includes an EVSE MAC address module 404, which receives a MAC address transmitted from the EV. This MAC address corresponds to an electric vehicle supply equipment (EVSE) unit to which the EV is physically connected. The MAC address uniquely identifies the EVSE and is used as a lookup key within the server's internal data structures.

The server 108 may further include a User ID 406, which receives the user identifier that was transmitted by the EV along with the MAC address. The User ID 406 may be associated with the driver, owner, or account holder attempting to initiate the charging session.

The EVSE MAC address 404 is coupled to a mapping module 408, which uses the MAC address to determine a corresponding Location ID and EVSE ID. The Location ID identifies the physical location of the charging site, and the EVSE ID identifies the particular charging unit or port within that location. These identifiers may be stored in a mapping database accessible to the cloud server.

The User ID 406 may be coupled to a subscription validation module 410, which verifies the status of the user's charging subscription. The subscription validation module 410 queries a database or account management system to confirm whether the user has an active subscription or access entitlement for the charging service. In some embodiments, the server may consider the type of subscription (e.g., pay-as-you-go, monthly plan, fleet account) and apply corresponding authorization logic.

A payment method module 412 is also shown, which may validate or retrieve billing information associated with the user. This may include confirming a linked credit card, digital wallet, prepaid balance, or invoice authorization. The server 108 may only proceed with authorizing the session if both subscription and payment method checks succeed.

Once the MAC address has been resolved and the user verified, the cloud-based authentication server 108 generates a remote activation command to the EVSE, authorizing it to begin charging the vehicle. This process avoids the use of digital certificates, simplifies interoperability across charge point operators, and enhances reliability.

Operations may further include selecting a preferred charging service provider based on user account preferences or pricing data. The charging session start command may include a session identifier and a predefined charge duration or energy limit.

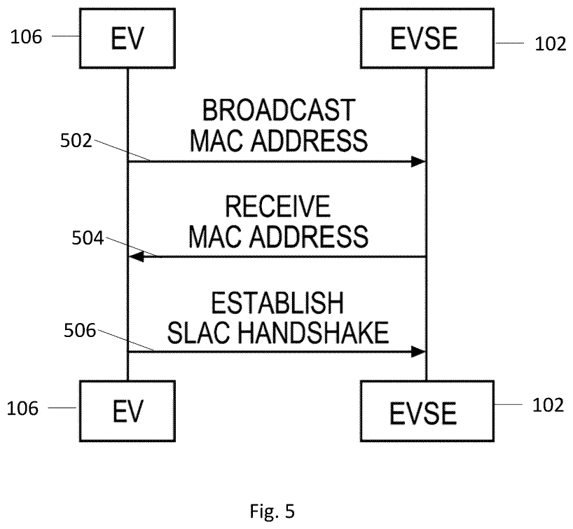

Referring now to FIG. 5, a sequence diagram is shown illustrating a SLAC handshake process between an EV 106 and an EVSE 102. This physical layer handshake enables communication between the EV and EVSE during the initial stages of a charging session, prior to any certificate-based or cloud-based authentication protocols.

At line 502, the EVSE 102 broadcasts its MAC address over a powerline communication (PLC) channel. This line occurs automatically upon detection of a vehicle connection or during a probe phase initiated by the EV. The MAC address serves as a unique hardware identifier for the EVSE and is intended to be received by the vehicle to begin the authentication process. In some embodiments, the MAC address may be encapsulated within SLAC protocol data units or other standard discovery messages.

At line 504, the EV 106 may receive the MAC address and begin establishing physical layer communication. This line typically involves sending SLAC response signals or acknowledgments to the EVSE. The communication may occur over HomePlug Green PHY or a similar low-bandwidth, low-latency PLC protocol defined in ISO/IEC 15118-3 or DIN 70121. The EV's communication module may include a PLC modem configured to operate on the control pilot line of the charging connector.

At line 506, the EV and EVSE complete the SLAC handshake, thereby confirming a successful physical connection and communication channel between the two entities. The SLAC handshake establishes the link conditions and pairing necessary for higher-layer protocol exchanges, even though in the system described herein, digital certificates are not used.

Once the SLAC handshake is completed and the MAC address has been successfully received, the EV 106 proceeds to transmit the MAC address, along with a user identifier (User ID), to the cloud-based authentication server (not shown in FIG. 5 but described with reference to FIG. 1 and FIG. 4). This triggers the certificateless authentication and EVSE mapping processes as previously described.

In some embodiments, the SLAC handshake may also be used to evaluate link quality, signal attenuation, or noise characteristics, which may further influence whether a charging session is initiated or how power is negotiated. Additionally, although SLAC is used in this example, the handshake may be substituted with any functionally equivalent layer-1 discovery and communication protocol, depending on the physical hardware of the EVSE.

The SLAC handshake process provides a secure and interoperable foundation for initiating communication between the EV and EVSE, while avoiding the complexity of certificate-based authorization and enabling reliable real-time authentication via cloud logic.

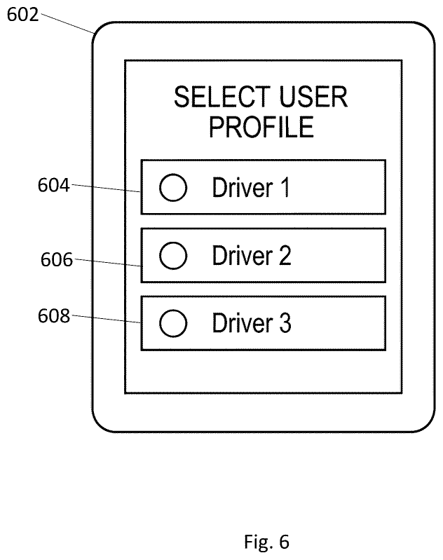

Referring now to FIG. 6, a graphical user interface is illustrated for multi-user profile selection in connection with a certificateless EV charging system. The interface may be rendered on a user device 602, which may include an in-vehicle display system, a central infotainment screen, a mobile application on a smartphone or tablet, or a wearable computing device. The purpose of the interface is to allow the driver or user to manually or automatically select a user profile to be associated with a forthcoming charging session.

The interface may display multiple selectable user profiles, shown in FIG. 6 as profile selections 604, 606, and 608 corresponding to Driver 1, Driver 2, and Driver 3, respectively. Each profile may be represented with a radio button, checkbox, or other selection mechanism that allows the user to identify themselves or their account. In one embodiment, the interface may support additional identifiers such as profile pictures, color themes, or role-based labels (e.g., primary user, guest, fleet driver).

Upon selection of a profile, a corresponding User ID is retrieved and stored for transmission to the cloud-based authentication server (described in FIGS. 1 and 4). The selected User ID will be used to validate the driver's eligibility and payment authorization for the charging session. The selected profile may be immediately transmitted upon plug-in, or it may be stored in local memory to be retrieved and sent when the EVSE MAC address is detected.

In some embodiments, the interface on the user device 602 may integrate with other vehicle systems to automate the user profile selection. For example: The system may auto-select a profile based on the paired smartphone, key fob, or mobile device detected near the vehicle; The system may apply logic based on time-of-day, driver history, or prior selection memory; and Biometric authentication, such as fingerprint or facial recognition, may trigger profile activation.

The user device 602 may also support configuration settings that define default profiles, parental controls, or corporate/fleet designations. For instance, in a shared-use scenario, the system may limit charging permissions to selected users or apply billing hierarchies based on employer or fleet account configurations.

In alternative embodiments, the user profile interface may be accessible remotely—such as through a mobile app—allowing the user to pre-select or switch profiles before approaching a charging station. This may be especially useful in multi-user households or shared vehicle models such as ride-sharing platforms.

The profile selection process shown in FIG. 6 provides a flexible and user-friendly mechanism for associating an individual identity with a charging session, supporting personalized authorization, billing, and usage tracking in a certificateless charging ecosystem.

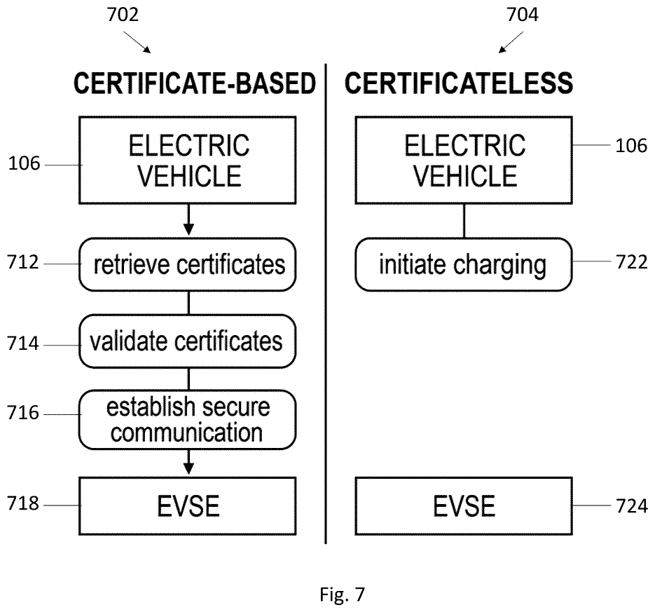

Referring now to FIG. 7, a comparative diagram is illustrated that contrasts a certificate-based charging architecture 702 with a certificateless charging architecture 704. This figure demonstrates the advantages of the certificateless system described in the present disclosure by presenting the relative procedural simplicity and reliability compared to conventional systems that rely on digital certificates.

On the left side of FIG. 7, the certificate-based model 702 is shown. An electric vehicle 106 initiates charging by first attempting to establish a secure and trusted session with an electric vehicle supply equipment (EVSE). This process typically includes multiple blocks:

At block 712, the vehicle retrieves one or more digital certificates stored locally, such as vehicle manufacturer certificates, eMobility service provider (eMSP) certificates, or contract-specific credentials.

At block 714, the vehicle and the EVSE engage in a mutual certificate validation process. This may involve verifying certificate chains, checking revocation lists, and ensuring that all certificates are current and trusted by each party.

At block 716, after successful validation, the vehicle and EVSE establish a secure communication session, such as through Transport Layer Security (TLS). Only after these cryptographic processes are completed is the vehicle permitted to interact with the EVSE to initiate charging.

At block 718, the EV communicates with the EVSE to formally request power delivery and begin the charging session.

Although this architecture may ensure high levels of cryptographic security, it introduces several disadvantages. These include a high rate of failure due to certificate expiration, revocation, or improper installation, as well as increased latency, engineering cost, and limited interoperability across networks that support different PKI infrastructures or ISO standards.

On the right side of FIG. 7, the certificateless model 704 of the present disclosure is depicted. An EV 106 initiates charging without relying on digital certificates or local cryptographic infrastructure.

At block 722, the vehicle receives a media access control (MAC) address from the connected EVSE and transmits this address, along with a user identifier (User ID), to a remote cloud-based authentication server. The server is responsible for mapping the MAC address to a corresponding Location ID or EVSE ID, validating the user's subscription status, and generating a remote start request.

In block 724, upon receipt of the remote start request, the EVSE begins delivering electrical energy to the vehicle. No certificate installation, validation, or secure channel establishment is necessary between the EV and EVSE at the time of charging.

This approach significantly reduces system complexity by removing the need for certificate lifecycle management, supports real-time and cloud-based user verification, and enables broader interoperability among charging station operators and service providers. Furthermore, it reduces session latency, enhances user experience, and allows for seamless user profile switching and eMSP roaming.

The certificateless model 704 thereby provides a reliable, scalable, and secure alternative to existing certificate-based systems, facilitating fast and user-friendly charging session initiation while minimizing operational burden on both vehicle and infrastructure components.

As used herein, the term “module” refers to any combination of hardware, firmware, and/or software configured to perform a specified function. A module may be implemented as a discrete component or integrated with other components within a larger system. For example, a module may be implemented as a microcontroller, an application-specific integrated circuit (ASIC), a programmable logic device (PLD), a field-programmable gate array (FPGA), a digital signal processor (DSP), one or more software routines or instructions executed by a processor, or any combination thereof.

It should be understood that the term “module” is intended to encompass a structure that may be physically distributed across multiple devices or subsystems but functions as a logical unit for performing a described function. The components of a module may communicate through various interconnection technologies, including wired or wireless buses, networks, or internal communication protocols. Unless explicitly stated otherwise, the term “module” should not be limited to any specific implementation or arrangement.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system for enabling certificateless electric vehicle (EV) charging, comprising:
an electric vehicle supply equipment (EVSE) configured to transmit a media access control (MAC) address upon physical connection; and
an EV configured to receive the MAC address and send it, along with a user identifier, to a cloud-based authentication server;
the cloud-based authentication server configured to:
map the MAC address to a location and EVSE identifier;
verify the user identifier and subscription status;
send a remote start command to the EVSE to initiate charging.

2. The method of claim 1, wherein the MAC address is received during a Signal Level Attenuation Characterization (SLAC) handshake.

3. The method of claim 1, wherein the cloud-based authentication server is operated by an original equipment manufacturer (OEM).

4. The method of claim 1, wherein verifying comprises checking a user subscription with one or more electric mobility service providers (eMSPs).

5. The method of claim 1, wherein the remote start command bypasses a Transport Layer Security (TLS) authentication.

6. The method of claim 1, further comprising logging the charging session to a cloud-based dashboard for user access.

7. The system of claim 1, wherein the EVSE does not support an ISO 15118 protocol.

8. The system of claim 1, wherein the EV is configured to communicate with the cloud-based authentication server via a cellular or wireless connection.

9. An electric vehicle (EV) configured to initiate a certificateless charging session, comprising:
a communication module receiving a media access control (MAC) address from an electric vehicle supply equipment (EVSE) during a handshake procedure upon physical connection; and
a network interface configured to transmit the received MAC address and a vehicle-associated user identifier to a remote cloud server;
wherein the cloud server maps the MAC address to a location identifier and EVSE identifier, verifies an active subscription associated with the user identifier, and transmits a charging session activation command to the EVSE based on the location identifier and EVSE identifier.

10. The EV of claim 9, wherein the handshake procedure comprises a Signal Level Attenuation Characterization (SLAC) exchange.

11. The EV of claim 9, wherein the communication module is configured to receive the MAC address over a HomePlug Green PHY (HPGP) protocol.

12. The EV of claim 9, wherein the network interface comprises a cellular modem or wireless transceiver.

13. The EV of claim 9, wherein the vehicle stores user identifiers for multiple drivers and selects the appropriate user based on key fob detection.

14. The EV of claim 9, wherein the EV is configured to display the EVSE's location and authentication status on a user interface.

15. The EV of claim 9, wherein the user identifier is linked to a digital wallet or payment method stored in the vehicle's infotainment system.

16. The EV of claim 9, wherein the instructions further cause the EV to retry communication with the cloud server in the event of a failed transmission.

17. A non-transitory computer-readable medium storing instructions that, when executed by a processor of a cloud server, cause the server to perform operations comprising:
receiving a media access control (MAC) address and user identifier from a connected electric vehicle (EV);
mapping the MAC address to a Location ID and EVSE ID;
verifying user credentials and payment status;
transmitting a charging session start command to a corresponding EVSE based on the Location ID and EVSE ID.

18. The non-transitory computer-readable medium storing instructions of claim 17, wherein the cloud server supports multiple user accounts per vehicle.

19. The non-transitory computer-readable medium of claim 17, wherein the operations further comprise selecting a preferred charging service provider based on user account preferences or pricing data.

20. The non-transitory computer-readable medium of claim 17, wherein the charging session start command includes a session identifier and a predefined charge duration or energy limit.
